(19) United States
(12) Patent Application Publication
(10) Pub. No.: US 2026/0155704 A1
(43) Pub. Date: Jun. 4, 2026

(54) ELECTRIC COMPRESSOR

(71) Applicant: SANDEN CORPORATION, Isesaki-shi, Gunma (JP)

(72) Inventors: Mikio KOBAYASHI, Ishisaki-shi, Gunma (JP); Toru ITO, Isesaki-shi, Gunma (JP)

(73) Assignee: SANDEN CORPORATION, Isesaki-shi, Gunma (JP)

(21) Appl. No.: 19/126,569

(22) PCT Filed: Oct. 25, 2023
(86) PCT No.: PCT/JP2023/038418

§ 371 Date: May 1, 2025

(30) Foreign Application Priority Data
Nov. 25, 2022 (JP) 2022-187956

(51) Int. Cl. H02K 7/14; B60H 1/32; H02K 11/33

(52) U.S. Cl. CPC H02K 7/14; B60H 1/3226; H02K 11/33; B60H 2001/3292

(57) ABSTRACT

There is provided an electric compressor having improved insulation between terminals of switching elements constituting an inverter. In an electric compressor including an electric motor, a compression mechanism driven by the electric motor, and an inverter that drives the electric motor, the inverter includes six switching elements Q1 to Q6 individually having three terminals 24a, 24b, and 24c protruding outward, and a root portion of the terminal 24b positioned at a middle among the three terminals 24a, 24b, and 24c of the switching elements Q1 to Q6 is covered with a cover portion 31 formed of an insulating resin.

### DESCRIPTION

### Technical Field

The present invention relates to an electric compressor integrally including an inverter device, and specifically relates to an electric compressor capable of being suitably used for a vehicle air-conditioning apparatus.

### Background Art

Many of electric compressors used for compressing a refrigerant in a vehicle air-conditioning apparatus integrally include an inverter, and the inverter converts DC power from an in-vehicle battery into AC power and supplies the AC power to an electric motor that drives a compression mechanism, and this enables driving the electric motor. One example of these electric compressors is described in Patent Literature 1. In the electric compressor described in Patent Literature 1, a plurality of power semiconductor elements (switching elements) constituting an inverter is radially disposed around a drive shaft in a plane intersecting the drive shaft of an electric motor in order to suppress thermal interference between adjacent power semiconductor elements.

### CITATION LIST

### Patent Literature

Patent Literature 1: JP-A-2010-275951

### SUMMARY OF INVENTION

### Problems to be Solved by Invention

In recent years, in order to enable quick charging and the like, a voltage of an in-vehicle battery is increased, and accordingly, power input to the switching element of the inverter is also increased. When the power input to the switching element is increased in voltage as described above, there is a possibility that an insulation distance between terminals of the switching element is insufficient, and its countermeasure has been desired.

Therefore, an object of the present invention is to provide an electric compressor in which insulation between terminals of switching elements constituting an inverter is improved.

### Solution to Problems

According to an aspect of the present invention, there is provided an electric compressor including an electric motor, a compression mechanism driven by the electric motor, and an inverter that drives the electric motor. In the electric compressor, the inverter includes a plurality of switching elements individually having a plurality of terminals protruding outward, and a root portion of at least one terminal of the individual switching elements is covered with a cover portion formed of an insulating resin.

### Effects of Invention

According to the present invention, it is possible to provide an electric compressor in which insulation between terminals of a switching element that is a component of an inverter is improved.

### BRIEF DESCRIPTION OF DRAWINGS

FIG. 1 is a schematic longitudinal sectional view of an electric compressor according to an embodiment.

FIG. 2 is a diagram showing an example of a circuit configuration of an inverter.

FIG. 3 is a diagram showing the inside of an inverter housing portion.

FIG. 4 is a cross-sectional view of a switching element.

FIG. 5 is a perspective view of the switching element as viewed from an upper surface side.

FIG. 6 is a perspective view of the switching element as viewed from a bottom surface side.

FIG. 7 is a top view of a switching element module.

FIG. 8 is a perspective view of the switching element module.

FIG. 9 is an enlarged cross-sectional view taken along line A-A of FIG. 7.

FIG. 10 is a diagram that illustrates installation of the switching element module and attachment of a circuit board.

FIG. 11 is a diagram that illustrates installation of the switching element module and attachment of the circuit board.

FIG. 12 is a diagram that illustrates installation of the switching element module and attachment of the circuit board.

FIG. 13 is a view showing the switching element in which a terminal is covered with a cover portion.

FIG. 14 is a diagram showing an example of a switching element module including two switching elements.

### DESCRIPTION OF EMBODIMENTS

In the following, an embodiment of the present invention will be described with reference to the accompanying drawings.

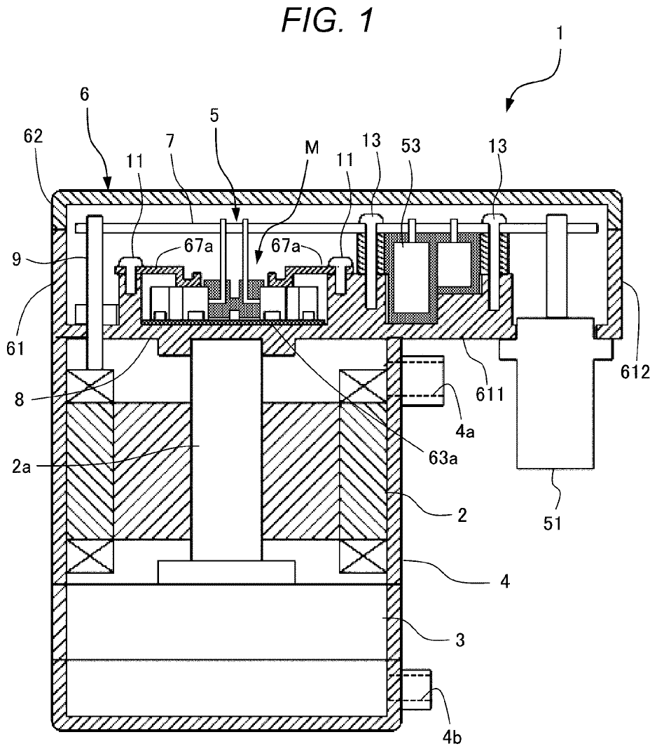

FIG. 1 is a schematic longitudinal sectional view of an electric compressor 1 according to an embodiment of the present invention. The electric compressor 1 according to the embodiment is an inverter-integrated electric compressor integrally including an inverter. The electric compressor 1 is mounted on a vehicle, for example, to constitute a part of a refrigerant circuit of a vehicle air-conditioning apparatus, and can be configured to compress and discharge a refrigerant.

Referring to FIG. 1, the electric compressor 1 includes an electric motor 2, a compression mechanism 3 that is driven by the electric motor to compress a refrigerant, a housing 4 that houses the electric motor 2 and the compression mechanism 3, an inverter device (hereinafter, simply referred to as an “inverter”) 5 that drives the electric motor 2, and an inverter housing portion 6 that houses the inverter 5.

The electric motor 2 is, for example, a three-phase synchronous motor. The compression mechanism 3 is, for example, a scroll compression mechanism. The housing 4 is formed in a bottomed cylindrical shape, and the electric motor 2 and the compression mechanism 3 are disposed in series in the axial direction in the housing 4. Specifically, in the housing 4, the electric motor 2 is disposed on one end side (upper side in FIG. 1), which is an open end of the housing 4, and the compression mechanism 3 is disposed on the other end side (lower side in FIG. 1), which is a closed end of the housing 4. An output shaft (drive shaft) 2a of the electric motor 2 is coupled to the compression mechanism 3 (a movable scroll in the case of a scroll compression mechanism).

The inverter 5 is formed with various electronic components mounted on a circuit board 7. The inverter housing portion 6 is provided integrally with the housing 4. The inverter housing portion 6 includes a housing main body 61 fixed to the one end of the housing 4 and a cover member 62.

The housing main body 61 has a bottom wall 611 and a peripheral wall 612 rising from a peripheral edge of the bottom wall 611. A part of the bottom wall 611 closes the one end (open end) of the housing 4. The peripheral wall 612 defines the inner space of the housing main body 61 and the opening of the housing main body 61 facing the bottom wall 611. The cover member 62 is attached to the housing main body 61 so as to close the opening.

The part of the bottom wall 611 that closes the one end (open end) of the housing 4 constitutes a partitioning wall 8 that partitions the inside of the housing 4 and the inside of the inverter housing portion 6. In addition, a power supply line 9 from the inverter 5 to the electric motor 2 extends penetrating through the partitioning wall 8 in an airtight and liquid-tight state.

The housing 4 is provided with a refrigerant inlet 4a through which a refrigerant from the outside flows into the housing 4. The refrigerant inlet 4a is formed at a site on the one end side of the side surface of the housing 4, that is, in the vicinity of the partitioning wall 8. The refrigerant flowing into the housing 4 from the refrigerant inlet 4a flows through the housing 4 (gap of the electric motor 2) to reach the compression mechanism 3. The compression mechanism 3 is driven by the electric motor 2 to suck, compress, and discharge the refrigerant.

The refrigerant flowing into the housing 4 from the refrigerant inlet 4a is a refrigerant that has passed through a condenser, an expansion valve, an evaporator, and the like in the refrigerant circuit of the vehicle air-conditioning apparatus, and is a low-temperature and low-pressure refrigerant. Therefore, the partitioning wall 8 and the electric motor 2 can be cooled by the refrigerant flowing into the housing 4. The refrigerant having flowed in the housing 4 is compressed into a high-temperature high-pressure refrigerant by the compression mechanism 3, and is discharged from the compression mechanism 3. Then, the (high-temperature and high-pressure) refrigerant discharged from the compression mechanism 3 flows out from a refrigerant outlet 4b formed in a site on the other end side of the side surface of the housing 4.

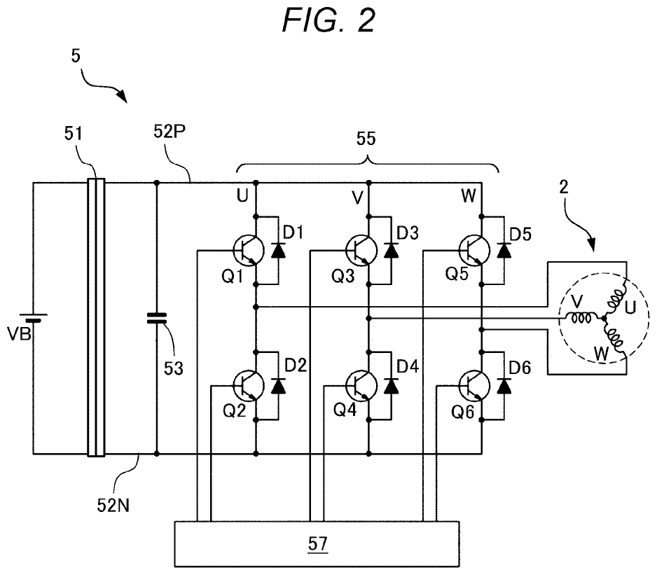

FIG. 2 is a diagram showing an example of the circuit configuration of the inverter 5. The inverter 5 is connected to an external power supply (e.g., an in-vehicle battery) VB via a connector 51, and is configured to convert DC power from the external power supply VB into three-phase AC power and supply the three-phase AC power to the electric motor 2.

Referring to FIG. 2, the inverter 5 includes a smoothing capacitor 53, a switching unit 55, and a control unit 57. These components are mounted on the circuit board 7 to form the inverter 5.

The smoothing capacitor 53 is connected between a positive bus bar 52P and a negative bus bar 52N connected to the external power supply VB. The smoothing capacitor 53 smooths the DC power supplied from the external power supply VB.

The switching unit 55 includes six switching elements Q1 to Q6 and six diodes D1 to D6. The switching unit 55 is configured to convert a DC voltage from the external power supply VB into a three-phase AC voltage and supply the three-phase AC voltage to the electric motor 2 by controlling (PMW control of) the six switching elements Q1 to Q6.

The switching unit 55 will be further described. The switching unit 55 includes a U-phase arm, a V-phase arm, and a W-phase arm provided in parallel between the positive bus bar 52P and the negative bus bar 52N. Two switching elements Q1 and Q2 are connected in series to the U-phase arm, and the diodes D1 and D2 are connected in anti-parallel to the switching elements Q1 and Q2, respectively. Two switching elements Q3 and Q4 are connected in series to the V-phase arm, and the diodes D3 and D4 are connected in anti-parallel to the switching elements Q3 and Q4, respectively.

Two switching elements Q5 and Q6 are connected in series to the W-phase arm, and the diodes D5 and D6 are connected in anti-parallel to the switching elements Q5 and Q6, respectively.

In addition, an intermediate point of each of the U-phase arm, the V-phase arm, and the W-phase arm is connected to the other end of a U-phase coil, a V-phase coil, and a W-phase coil of the electric motor 2, which are star-connected at one end of each of the U-phase arm, the V-phase arm, and the W-phase arm. That is, the intermediate point of the U-phase arm located between the switching elements Q1 and Q2 in the U-phase arm is connected to the U-phase coil, the intermediate point of the V-phase arm located between the switching elements Q3 and Q4 in the V-phase arm is connected to the V-phase coil, and the intermediate point of the V-phase arm located between the switching elements Q5 and Q6 in the W-phase arm is connected to the W-phase coil.

Then, by controlling the ratio of the ON periods of the three switching elements Q1, Q3, and Q5 on the positive bus bar 52P side and the ratio of the ON periods of the three switching elements Q2, Q4, and Q6 on the negative bus bar 52N side of each phase arm, that is, by controlling the six switching elements Q1 to Q6 by the duty ratio (PWM control), the switching unit 55 can convert DC power from the external power supply VB into three-phase AC power and supply the three-phase AC power to the electric motor 2, and this enables driving the electric motor 2.

The control unit 57 controls (PWM-controls) the six switching elements Q1 to Q6 in order to drive the electric motor 2 and the compression mechanism 3 based on a control signal from the outside (e.g., the control device of the vehicle air-conditioning apparatus described above).

Note that, for example, a noise filter that suppresses ripple noise, EMI/EMC noise, and the like may be provided between the connector 51 and the smoothing capacitor 53.

Next, a housing structure of the inverter 5 of the electric compressor 1 according to the embodiment will be described. As described above, in the present embodiment, the inverter 5 is housed in the inverter housing portion 6.

### Inverter Housing Portion 6

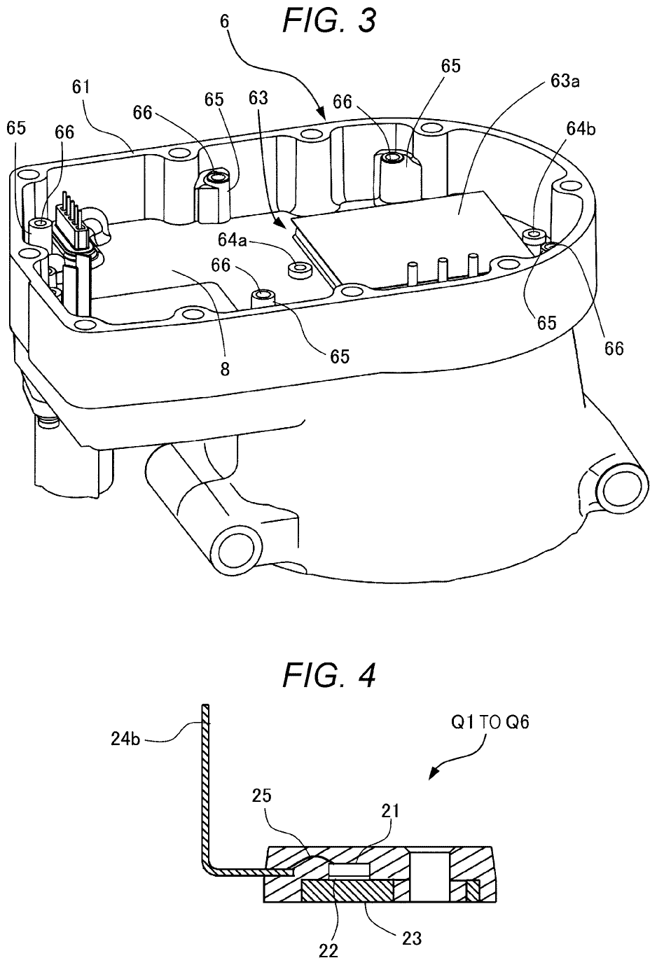

FIG. 3 is a diagram showing the inside of the inverter housing portion 6. As shown in FIG. 3, the inverter housing portion 6 includes an installation portion 63 in which the six switching elements Q1 to Q6 are installed, and a plurality of substrate support portions 65 that supports the circuit board 7 constituting the inverter 5.

The installation portion 63 is provided on the inner bottom surface of the housing main body 61, that is, the surface of the partitioning wall 8 on the inverter housing portion 6 side. In the installation portion 63, an insulating heat dissipation sheet 63a is disposed. In addition, in the inner bottom surface of the housing main body 61, a first bolt hole 64a and a second bolt hole 64a are formed with the installation portion 63 interposed therebetween.

The plurality of substrate support portions 65 is configured to support the circuit board 7 at positions away from (the surface on the inverter housing portion 6 side) of the partitioning wall 8 from the installation portion 63. That is, in the inverter housing portion 6, the circuit board 7 is disposed at a position closer to the cover member 62 from the six switching elements Q1 to Q6. The plurality of substrate support portions 65 is provided at intervals from each other in the peripheral edge portion of the inner bottom surface of the housing main body 61. The plurality of substrate support portions 65 is individually formed to protrude from the inner bottom surface of the housing main body 61, that is, the surface of the partitioning wall 8 on the inverter housing portion 6 side, and a third bolt hole 66 is formed in its distal end surface.

### Switching Elements Q1 to Q6 and Switching Element Module M

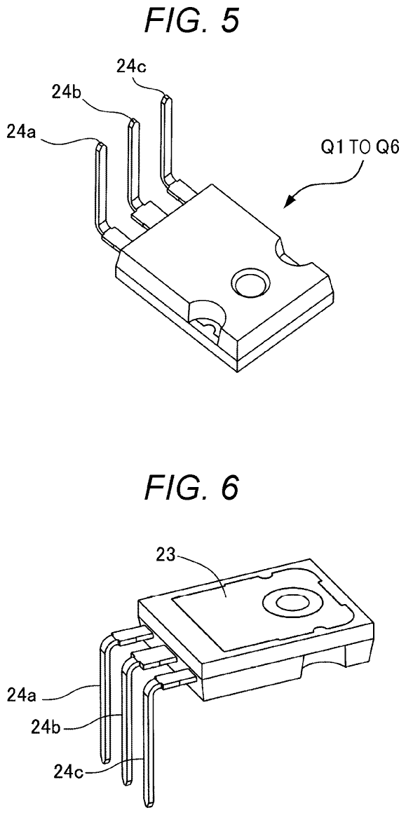

FIG. 4 is a cross-sectional view of each of the six switching elements Q1 to Q6, FIG. 5 is a view of each of the six switching elements Q1 to Q6 as viewed from the top surface side, and FIG. 6 is a view of each of the six switching elements Q1 to Q6 as viewed from the bottom surface side.

Each of the six switching elements Q1 to Q6 is packaged by resin-sealing a semiconductor chip 21 such as an insulated gate bipolar transistor (IGBT). Specifically, each of the six switching elements Q1 to Q6 is configured such that a semiconductor chip (die) 21 is fixed to a die pad 23 via an insulating die bond 22, the semiconductor chip and one end side of each of three lead terminals (hereinafter simply referred to as “terminals”) 24a, 24b, and 24c are connected by a bonding wire 25, and these are resin-sealed. Each of the three terminals 24a, 24b, and 24c extends outward from the one end side to which the bonding wire 25 is connected. That is, each of the six switching elements Q1 to Q6 includes the die pad 23 and the three terminals 24a, 24b, and 24c protruding outward.

Since the die pad 23 mainly radiates heat generated in the semiconductor chip 21, a part of the bottom surface is exposed to be flush with the bottom surface of the package. That is, a part of the die pad 23 is exposed on the bottom surface of each of the six switching elements Q1 to Q6.

The three terminals 24a, 24b, and 24c extend in the same direction from the side surface of the package in a state of being spaced apart from each other. More specifically, each of the three terminals 24a, 24b, and 24c extends sideways from the side surface in each of the six switching elements Q1 to Q6, and then is bent at a substantially right angle such that the distal end portion faces upward. In each of the three terminals 24a, 24b, and 24c, a root portion, that is, a portion in a predetermined range on the proximal end side is formed to be wider than the other portions. In other words, in each of the three terminals 24a, 24b, and 24c, the portion extending to the side is formed to be wider than the distal end side.

In the present embodiment, the six switching elements Q1 to Q6 are coupled with an insulating resin in a state of being disposed in two rows at intervals, and are integrated as a switching element module M. Therefore, in the present embodiment, the switching element module M is installed in the installation portion 63 of the inverter housing portion 6.

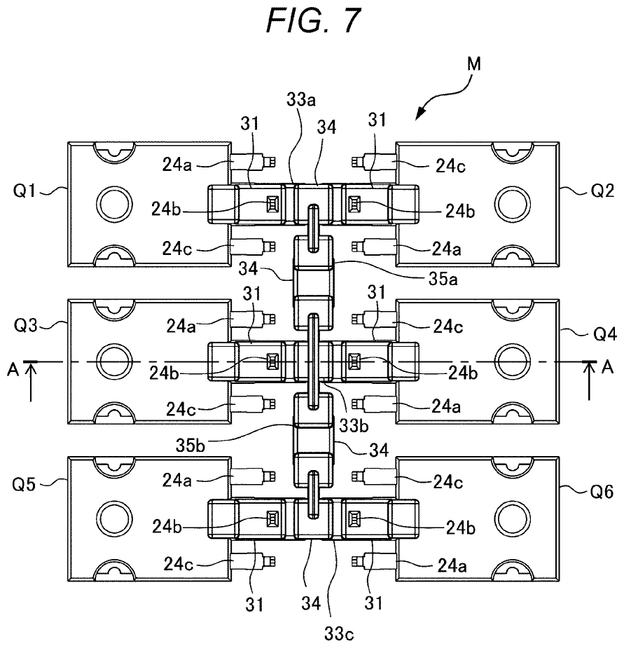

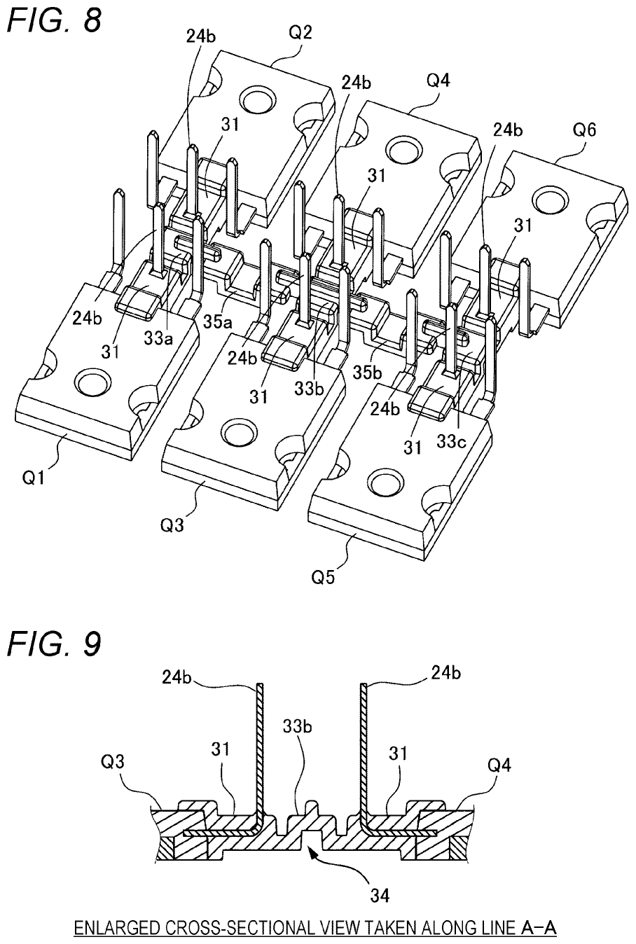

FIG. 7 is a top view of the switching element module M, FIG. 8 is a perspective view of the switching element module M, and FIG. 9 is an enlarged cross-sectional view taken along line A-A of FIG. 7.

Referring to FIGS. 7 to 9, in each of the six switching elements Q1 to Q6, a root portion (i.e., a portion of a predetermined range on the proximal end side) of the terminal 24b positioned in the middle of the three terminals 24a, 24b, and 24c is covered with a cover portion 31 formed of an insulating resin. Specifically, in each of the six switching elements Q1 to Q6, a portion extending to the side of the terminal 24b positioned in the middle and a part of the package in the vicinity are covered with the cover portion 31.

In addition, the six switching elements Q1 to Q6 are coupled and integrated with three first coupling portions 33a, 33b, and 33c and two second coupling portions 35a and 35b formed of the same insulating resin as the cover portion 31.

Specifically, the switching element Q1 and the switching element Q2 which form a first “pair” among the six switching elements Q1 to Q6 are disposed such that three terminals 24a, 24b, and 24c of the switching element Q1 and the switching element Q2 face each other, and the cover portions 31 of the switching elements Q1 and Q2 are coupled to each other by the first coupling portion 33a. In addition, the switching element Q3 and the switching element Q4 which form a second “pair” are disposed such that the three terminals 24a, 24b, and 24c of the switching element Q3 and the switching element Q4 face each other, and the cover portions 31 of the switching element Q3 and the switching element Q4 are coupled to each other by the first coupling portion 33b. Further, the switching element Q5 and the switching element Q6 which form a third “pair” are disposed such that the three terminals 24a, 24b, and 24c of the switching element Q5 and the switching element Q6 face each other, and the cover portions 31 of the switching element Q5 and the switching element Q6 are coupled to each other by the first coupling portion 33c.

The first coupling portion 33a and the first coupling portion 33b adjacent to each other are coupled by a second coupling portion 35a extending in a direction intersecting with each other, and the first coupling portion 33b and the first coupling portion 33c adjacent to each other are coupled by a second coupling portion 35b extending in a direction intersecting with each other.

Here, the insulating resin is a thermoplastic resin, and the six cover portions 31, the three first coupling portions 33a, 33b, and 33c, and the two second coupling portions 35a and 35b are simultaneously formed by injection molding. Preferably, the six cover portions 31, the three first coupling portions 33a, 33b, and 33c, and the two second coupling portions 35a and 35b are formed by low pressure molding (hot melt molding) in which a low melting point thermoplastic resin is injected at low pressure.

In addition, in the present embodiment, the cover portion 31 is formed in a rectangular block shape that encloses the root portion of the terminal 22b positioned in the middle and is coupled to the package. That is, the cover portion 31 is formed to have a certain degree of rigidity.

Meanwhile, each of the three first coupling portions 33a, 33b, and 33c is formed to have rigidity lower than that of the cover portion 31. Specifically, in the present embodiment, each of the three first coupling portions 33a, 33b, and 33c has an elastic deformation portion 34 that is easily elastically deformed, and is configured to be able to expand and contract the interval between the two switching elements coupled by each of the three first coupling portions 33a, 33b, and 33c with the elastic deformation of the elastic deformation portion 34. The elastic deformation portion 34 is, for example, thinner than the cover portion 31 and can be formed in a U-shaped cross section (see FIG. 9).

Similarly, each of the two second coupling portions 35a and 35b is formed to have rigidity lower than that of the cover portion 31. Each of the two second coupling portions 35a and 35b has the elastic deformation portion 34 that is easily elastically deformed, and is configured to be able to expand and contract the interval between the two first coupling portions coupled by each of the two second coupling portions 35a and 35b with the elastic deformation of the elastic deformation portion 34. Note that here, the shapes of the elastic deformation portions of the first coupling portions 33a, 33b, and 33c and the shapes of the elastic deformation portions of the second coupling portions 35a and 35b are formed to be the same, but these shapes may be different.

### Installation of the Switching Element Module M and Attachment of the Circuit Board 7

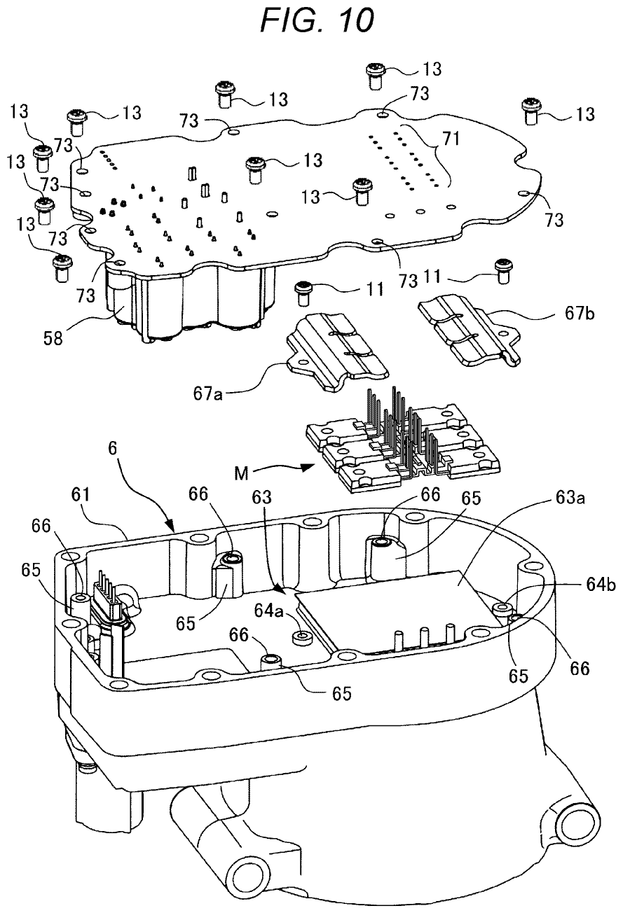

FIGS. 10 to 12 are diagrams that explains installation of the switching element module M and attachment of the circuit board 7. In the present embodiment, installation of the switching element module M and attachment of the circuit board 7 are performed by the following procedure.

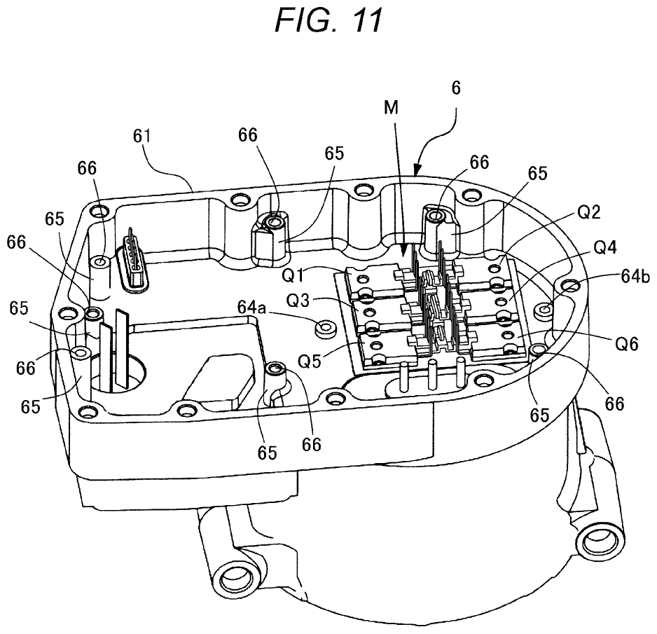

First, the switching element module M is placed on the installation portion 63 (i.e., the insulating heat dissipation sheet 63a) (FIG. 11).

Subsequently, a first pressing member 67a is fixed to the first bolt hole 64a by a first fixing bolt 11, and a second pressing member 67b is fixed to the second bolt hole 64b by the first fixing bolt 11. At this time, the first pressing member 67a presses the upper surfaces of the three switching elements Q1, Q3, and Q5 so as to press the bottom surfaces of the three switching elements Q1, Q3, and Q5 in the switching element module M against the installation portion 63 (insulating heat dissipation sheet 63a), and the second pressing member 67b presses the upper surfaces of the three switching elements Q2, Q4, and Q6 so as to press the bottom surfaces of the remaining three switching elements Q2, Q4, and Q6 against the installation portion 63 (insulating heat dissipation sheet 63a). As a result, the switching element module M is installed (fixed) in the installation portion 63 (FIG. 12).

Subsequently, the circuit board 7 is placed on the substrate support portion 65.

In the present embodiment, electronic components other than the six switching elements Q1 to Q6 among the various electronic components constituting the inverter 5 are mounted on the circuit board 7 in advance. Specifically, the smoothing capacitor 53, the diodes D1 to D6, the control unit 57, and the like are mounted on the circuit board 7 in advance. Here, the smoothing capacitor 53 is mounted on the circuit board 7 in a state of being housed in the case 58 together with the above-described noise filter and the like and sealed with an insulating resin.

In addition, in the circuit board 7, 18 terminal holes 71 through which the three terminals 24a, 24b, and 24c of the six switching elements Q1 to Q6 are inserted are formed. Further, a plurality of bolt insertion holes 73 is formed in the peripheral edge portion of the circuit board 7. The plurality of bolt insertion holes 73 is disposed so as to correspond to the plurality of substrate support portions 65.

Then, as shown in FIG. 10, the circuit board 7 is placed on the upper surface of the substrate support portion 65 of the inverter housing portion 6 with one surface (mounting surface) on which electronic components other than the six switching elements Q1 to Q6 are mounted facing downward. At this time, the plurality of bolt insertion holes 73 of the circuit board 7 is disposed on the third bolt holes 66 formed on the upper surfaces of the plurality of substrate support portions 65, each of the terminals 24a, 24b, and 24c of the six switching elements Q1 to Q6 is inserted into the corresponding terminal hole 71 of the circuit board 7, and the distal end portion protrudes from the other surface of the circuit board 7.

After that, the circuit board 7 placed on the upper surfaces of the plurality of substrate support portions 65 is fixed to the substrate support portion 65 by the plurality of second fixing bolts 13. In addition, the distal end portions of the terminals 24a, 24b, and 24c of the six switching elements Q1 to Q6 are soldered to the circuit board 7, so that the six switching elements Q1 to Q6 are electrically connected to the circuit board 7.

Note that although detailed description is omitted, the power supply line 9 (or its terminal portion) is also inserted into an insertion hole formed in the circuit board 7, its distal end portion protrudes from the other surface of the circuit board 7, and is electrically connected to the circuit board 7 by, e.g., a connection member and the like, not shown. In addition, the circuit board 7 is electrically connected to the external power supply VB via the connector 51 when placed on the substrate support portion 65.

### Attachment of the cover Member 62

After the circuit board 7 is attached to the substrate support portion 65 and the above-described electrical connection is made, the cover member 62 is attached to the housing main body 61 via a fastening bolt (not shown) or the like. In this manner, the inverter 5 is housed in the inverter housing portion 6.

The electric compressor 1 according to the present embodiment provides the following effects.

The root portion of the terminal 24b positioned in the middle of the three terminals 24a, 24b, 24c of each of the six switching elements Q1 to Q6 constituting the inverter 5 is covered with the cover portion 31 formed of an insulating resin. Therefore, the insulation between the terminals is improved in each of the six switching elements Q1 to Q6.

In addition, the six switching elements Q1 to Q6 are coupled in a state of being spaced apart from each other and integrated as the switching element module M.

Specifically, among the six switching elements Q1 to Q6, two switching elements (Q1 and Q2, Q3 and Q4, and Q5 and Q6) forming a “pair” are disposed such that the three terminals 24a, 24b, and 24c face each other, and the cover portions 31 are coupled to each other by the first coupling portion (33a, 33b, 33c) formed of the same insulating resin as the cover portion 31. In addition, the adjacent first coupling portions (33a and 33b, 33b and 33c) are coupled to each other by the second coupling portion (35a, 35b) formed of the same insulating resin as the cover portion 31.

Then, the switching element module M is installed in the installation portion 63 of the inverter housing portion 6. That is, the six switching elements Q1 to Q6 can be installed at one time. Therefore, assembling workability of the six switching elements Q1 to Q6 is improved as compared with the conventional technique.

Here, the insulating resin is a thermoplastic resin, and the six cover portions 31, the three first coupling portions 33a, 33b, and 33c, and the two second coupling portions 35a and 35b are molded at a time by injection molding. Therefore, modularization of the six switching elements Q1 to Q6 is easy, and the individual switching elements Q1 to Q6 can be formed in an arbitrary shape.

Specifically, in the present embodiment, the cover portion 31 is formed in a rectangular block shape that encloses the root portion of the terminal 22b positioned in the middle and is coupled to the package, and has a certain degree of rigidity. Therefore, the creepage distance between the terminals is secured, and inadvertent deformation, breakage, or the like of the terminal 22b in the middle can be prevented.

Meanwhile, each of the three first coupling portions 33a, 33b, and 33c has the elastic deformation portion 34 that is easily elastically deformed, and is configured to be able to expand and contract the interval between the two switching elements (Q1 and Q2, Q3 and Q4, Q5 and Q6) coupled by each of the three first coupling portions 33a, 33b, and 33c with the elastic deformation of the elastic deformation portion 34. Similarly, each of the two second coupling portions 35a and 35b has the elastic deformation portion 34 that is easily elastically deformed, and is configured to be able to expand and contract the interval between the two first coupling portions (33a and 33b, 33b and 33c) coupled by each of the two second coupling portions 35a and 35b with the elastic deformation of the elastic deformation portion 34. Therefore, in the switching element module M, the position of each of the six switching elements Q1 to Q6 can be adjusted, and the assembling workability of the six switching elements Q1 to Q6 is further improved.

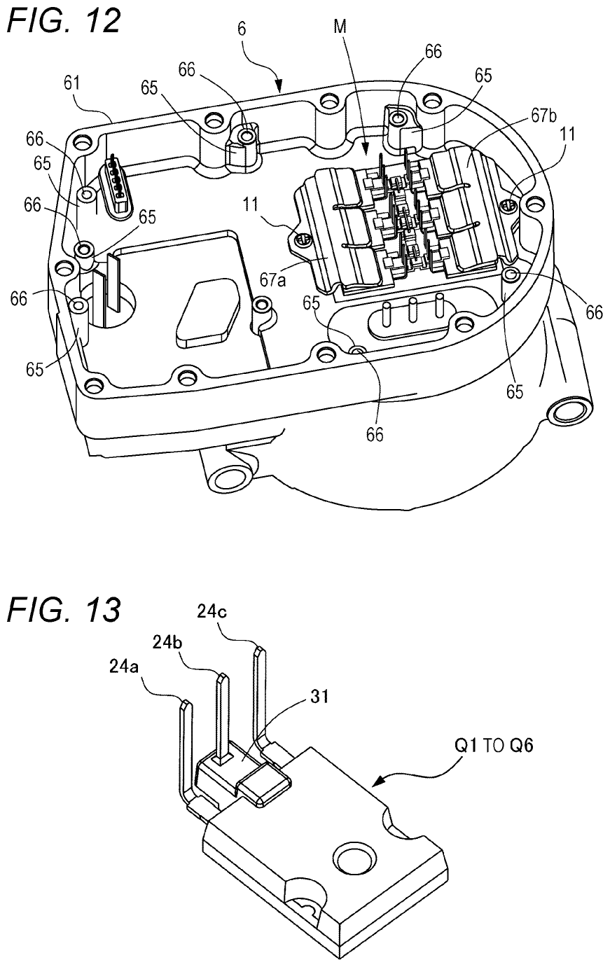

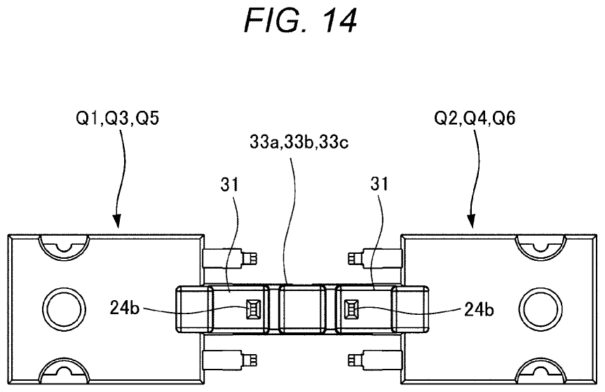

Note that in the above-described embodiment, the six switching elements Q1 to Q6 are integrated as the switching element module M, and the switching element module M is installed in the installation portion 63 of the inverter housing portion 6. However, the configuration is not limited to this. For example, as shown in FIG. 13, in each of the six switching elements Q1 to Q6, the root portion of the terminal 24b positioned in the middle may be covered with the cover portion 31, and the six switching elements Q1 to Q6 may be individually placed on the installation portion 63 of the inverter housing portion 6. Alternatively, as shown in FIG. 14, two switching elements (Q1 and Q2, Q3 and Q4, Q5 and Q6) forming a “pair” may be integrated as a switching element module, and the switching element modules may be individually placed on the installation portion 63 of the inverter housing portion 6.

In addition, in the above embodiment, each of the six switching elements Q1 to Q6 has three terminals 24a, 24b, and 24c protruding outward, and the root portion of the terminal 24b positioned in the middle is covered with the cover portion 31. However, the configuration is not limited to this. All of the root portions of the three terminals 24a, 24b, and 24c may be covered with the cover portion 31.

Alternatively, when each of the six switching elements Q1 to Q6 has four terminals, the root portions of all of the terminals or root portions of two terminals located in the middle (i.e., terminals other than the terminals on both sides) may be covered with the cover portion 31.

As described above, the embodiment of the present invention and its modifications have been described above. However, the present invention is not limited to the foregoing embodiment and modifications, and as a matter of course, the present invention can be further modified based on the technical idea of the present invention.

### LIST OF REFERENCE SIGNS

1 Electric compressor
2 Electric motor
3 Compression mechanism
4 Housing
5 Inverter
6 Inverter housing portion
7 Circuit board
8 Partitioning wall
24a, 24b, 24c Terminal
31 Cover portion
33a, 33b, 33c First coupling portion
35a, 35b Second coupling portion
61 Housing main body
62 Cover member
63 Installation portion
65 Substrate support portion
M Switching element module
Q1 to Q6 Switching element

1. An electric compressor comprising:
an electric motor; a compression mechanism driven by the electric motor; and an inverter that drives the electric motor, wherein
the inverter includes a plurality of switching elements individually having a plurality of terminals protruding outward, and
a root portion of at least one terminal of the switching elements is covered with a cover portion formed of an insulating resin.

2. The electric compressor according to claim 1, wherein
the switching elements has three or more terminals extending in a same direction, and
a root portion of at least one terminal located in the middle of the three or more terminals of the switching elements is covered with the cover portion.

3. The electric compressor according to claim 2, wherein
the three or more terminals extends laterally and then is bent at a substantially right angle, and has a distal end portion facing upward, and
the laterally extending portion of the at least one terminal located in the middle is covered with the cover portion.

4. The electric compressor according to claim 3, wherein two switching elements constituting a pair among the plurality of switching elements are disposed such that a plurality of terminals of the switching elements faces each other, and the cover portions of the switching elements are coupled to each other by a first coupling portion formed of a same insulating resin as the cover portion.

5. The electric compressor according to claim 4, wherein the first coupling portions that are adjacent to each other are coupled to each other by a second coupling portion extending in a direction intersecting the first coupling portion and formed of the same insulating resin as the cover portion.

6. The electric compressor according to claim 5, wherein
the cover portion is formed in a block shape so as to have rigidity, and
the first coupling portion and the second coupling portion are formed to have an elastic deformation portion that is thinner than the cover portion and is easily elastically deformed.

7. The electric compressor according to claim 1, wherein the insulating resin is a thermoplastic resin.
